(19) United States
(12) Patent Application Publication
(10) Pub. No.: US 2025/0207973 A1
(43) Pub. Date: Jun. 26, 2025

(54) ANTENNA VIBRATION MONITORING SYSTEM

(71) Applicant: Telecom Italia S.p.A., Milano (IT)

(72) Inventors: Carmen CRIMINISI, Roma (IT); Davide MICHELI, Roma (IT); Giuliano MURATORE, Rocca Priora, Roma (IT); Aldo VANNELLI, Roma (IT)

(73) Assignee: Telecom Italia S.p.A., Milano (IT)

(21) Appl. No.: 18/848,922

(22) PCT Filed: Mar. 16, 2023
(86) PCT No.: PCT/EP2023/056810

§ 371 Date: Sep. 20, 2024

(30) Foreign Application Priority Data
Mar. 23, 2022 (IT) 102022000005756

(51) Int. Cl. G01H 17/00; H04W 24/08

(52) U.S. Cl. CPC G01H 17/00; H04W 24/08

(57) ABSTRACT

A system for monitoring antenna vibrations in fixed-location base stations within mobile communication networks. Each base station, equipped with at least one antenna for transmitting and receiving radio waves, serves a specific cell and enables data exchange with user equipment. The system collects radio measurements from user devices in the cell to generate an electromagnetic print of the antenna, which shows how its radiation pattern changes over time. This print is used to assess oscillation conditions of the antenna's supporting structure, identifying any vibrations that may impact performance.

### BACKGROUND OF THE PRESENT INVENTION

### Field of the Present Invention

The present invention generally relates to the communication networks field. More particularly, the present invention relates to a system for monitoring oscillations/vibrations of antenna structures for communication networks.

### Overview of the Related Art

Mobile communication networks, such as 3G, 4G and 5G communication networks, enable user equipment (e.g., smartphone, tablet, laptops) within land areas defined “cells” to communicate (e.g., by exchanging data) with other communication devices (e.g., with other user equipment). Each cell of a mobile communication network is served by at least one corresponding fixed-location base station (such as a NodeB for 3G mobile networks, a eNodeB for 4G mobile networks, and/or a GNodeB for 5G mobile networks) equipped with or coupled to one or more antenna structures.

By “antenna structure” it is herein intended an assembly comprising at least one ore more antennas (comprising radiating elements) and supporting members thereof (for example, a mast, or a tower).

In order to allow an effective radio coverage of the cells, the antennas are carefully fixed to the supporting member(s) in order to exhibit specific orientations, both in the azimuthal and in the zenithal planes.

Antenna structures for mobile communication networks are usually constructed in such a way to be able to withstand mechanical stresses caused by external causes-such as winds, earthquakes, impacts, acts of vandalism—by oscillating without causing stability issues as long as the mechanical stresses are within predetermined limits and as long as the materials of the antenna structures are not affected by excessive wear.

When an antenna structure is oscillating in response to mechanical stresses, the orientation of the antennas is altered, causing a corresponding alteration in the antenna directivity and a corresponding alteration of the signal coverage within the cell.

For these reason, in order to guarantee an improved reliability of a mobile communication network, it is therefore desirable to provide a system capable of assessing when an antenna structure is oscillating.

According to known solutions, an antenna structure may be equipped with proper sensors (e.g., gyroscopes and accelerometers), for example connected to the supporting member. In this way, when the antenna structure is oscillating, an oscillating condition of the antenna structure may be detected through the measurements carried out by the sensors while the latter oscillate together with the supporting member.

U.S. Pat. No. 10,257,592 discloses systems, methods, and circuits configured to monitor the displacement of a tower, report the monitored displacement via a networked connection, and determine that the tower is in a non-optimal state. By providing the aspects disclosed herein, an operator of a tower may optimize the tower's function, and potentially prevent the tower from breaking at an earlier stage.

US 2014/0278150 discloses an apparatus and methods involved in the process of assessing utility pole condition and, in particular, the apparatus and methods involved in the use of sensors to assess utility pole fatigue in response to age, weather, wear, impact and other potential damage events. A utility pole sensor system is provided for rapidly and efficiently assessing utility pole fatigue in response to passively induced environmental movements prior to a natural or man-made failure of the utility pole.

WO 2020/018753 discloses a tower monitoring system for monitoring a remote tower for structural evaluation and analysis. The tower monitoring system includes a sensor unit that takes tower data readings that include displacement readings. The sensor unit provides the tower data readings to a ground control unit near the tower. A remote server is in communication with the ground control unit and includes a secondary source of data, such as historical data of the tower, current data or historic data from nearby towers, and nearby weather and geological data. The monitoring system implements a modal analysis to determine contributions to the displacement readings and alarms an operator if the modal readings indicate structural stress beyond a predetermined threshold. Data is saved and can be used in a trend analysis to review any changes in the tower displacement readings over a period of time.

### SUMMARY OF THE PRESENT INVENTION

The solutions known in the art are based on the idea of providing dedicated sensor devices properly configured to measure mechanical quantities (such as for example accelerations). This approach is not efficient, being affected by several drawbacks.

Indeed, having to equip each antenna structure of a mobile communication network with dedicated sensor devices is a time consuming and costly procedure.

Moreover, the sensor devices need to be supplied with electric power, for example through wirings connected to an electric power source.

Furthermore, in order to guarantee a proper operation thereof, the sensor devices require to be periodically subjected to maintenance operations.

The abovementioned drawbacks are strongly exacerbated by the large number of different antenna structures encompassed by typical mobile communication networks.

In view of the above, Applicant has devised a solution to efficiently assess oscillations of antenna structures of fixed-location base stations of a mobile communication network that is not affected by the above-mentioned drawbacks.

One or more aspects of the present invention are set out in the independent claims, with advantageous features of the same invention that are indicated in the dependent claims, whose wording is enclosed herein verbatim by reference (with any advantageous feature being provided with reference to a specific aspect of the present that applies mutatis mutandis to any other aspect thereof).

An aspect of the present invention relates to an antenna vibration monitoring system for assessing oscillations of antenna structures of fixed-location base stations of a mobile communication network.

Each base station provides radio coverage over a corresponding cell.

Each base station comprises at least one corresponding antenna structure comprising a supporting member supporting at least one antenna configured to radiate/receive radio waves to/from portions of the cell to allow user equipment within the cell to exchange data traffic.

The antenna vibration monitoring system is configured to collect radio measurements pertaining to the electromagnetic operation of an antenna of a base station.

Said radio measurements are carried out by user equipment located in the cell corresponding to said base station.

The antenna vibration monitoring system is configured to generate an electromagnetic print of said antenna using said collected radio measurements.

Said electromagnetic print provides an indication of how a radiation pattern of the antenna varies over time across the cell.

The antenna vibration monitoring system is configured to assess an oscillation condition of the antenna structure of said base station, in which the supporting member is oscillating, based on said generated electromagnetic print of the antenna of said base station.

Thanks to this solution, it is possible to check in quasi-real-time the condition (rest or oscillating) of the antenna structures without being forced to install dedicated sensors (such as gyroscope and/or accelerometers) on every antenna structure, dramatically reducing the installation and maintenance costs.

According to an embodiment of the present invention, the antenna vibration monitoring system is further configured to store for each base station a corresponding reference electromagnetic print of the antenna of said base station corresponding to the electromagnetic print of said antenna when the supporting member supporting said at least one antenna is in a rest condition.

According to an embodiment of the present invention, the antenna vibration monitoring system is further configured to assess said oscillation condition of the antenna structure of said base station by comparing said generated electromagnetic print of the antenna of said base station with the reference electromagnetic print of said antenna.

According to an embodiment of the present invention, the antenna vibration monitoring system is configured to assess a rest condition of said antenna structure of said base station, in which the supporting member thereof is not oscillating, when said generated electromagnetic print of the antenna of said base station is substantially equal to said reference electromagnetic print of the antenna of said base station.

According to an embodiment of the present invention, the antenna vibration monitoring system is configured to assess said oscillation condition of the antenna structure of said base station when said generated electromagnetic print of the antenna of said base station varies over time with respect to said reference electromagnetic print of the antenna of said base station.

Since the reference electromagnetic print corresponds to the electromagnetic print of the antenna when the supporting member thereof is in a rest condition, said reference electromagnetic print may be subjected to variations over time that are mainly due to errors/imprecisions in the radio measurements carried out by the user equipment, and/or to the actual spatial distribution of the user equipment over the geographical area covered by the corresponding cell. When an antenna structure is in an oscillation condition because of mechanical stresses that are being induced by external causes such as winds or earthquakes, the generated electromagnetic print is subject to variations over time that are also due (in addition to the errors/imprecisions in the radio measurements, and/or to the actual spatial distribution of the user equipment) to the mechanical oscillation of the supporting member of the antenna structure. In view of the above, the use of the reference electromagnetic print as a reference for assessing an oscillation condition or a rest condition is very efficient, because a comparison between an electromagnetic print generated using the collected radio measurements and the corresponding reference electromagnetic print allows to efficiently identify the variations over time in the generated electromagnetic print due to the actual mechanical oscillations of the supporting member, filtering out variations due to other causes different from the actual mechanical oscillations.

According to an embodiment of the present invention, the antenna vibration monitoring system comprises or is coupled to an artificial intelligence unit trained to discriminate between said rest condition and said oscillation condition of the antenna structure of a base station by comparing a current evolution over time of the generated electromagnetic print of the antenna of said base station with the reference electromagnetic print of the antenna of said base station.

According to an embodiment of the present invention, said artificial intelligence unit is trained with a first data set comprising radio measurements collected in a situation in which it is assured that the antenna structure of said base station is in the rest condition.

According to an embodiment of the present invention, said artificial intelligence unit is trained with a second data set comprising radio measurements collected in a situation in which it is assured that the antenna structure of said base station is in the oscillation condition.

According to an embodiment of the present invention, the antenna structure of said base station further comprises at least one between gyroscope and accelerometer sensors coupled to the supporting member of said base station.

According to an embodiment of the present invention, said artificial intelligence unit is further trained by exploiting also data generated by said gyroscope and/or accelerometer sensors.

According to an embodiment of the present invention, the antenna vibration monitoring system is configured to determine an oscillation frequency of an antenna structure of a base station, when said antenna structure has been assessed to be in the oscillation condition, based on a frequency with which the generated electromagnetic print of the antenna of said base station oscillates with respect to the reference electromagnetic print of said antenna.

According to an embodiment of the present invention, the antenna vibration monitoring system is configured to determine at least one between:
an intensity of the oscillations of an antenna structure of a base station, when said antenna structure has been assessed to be in the oscillation condition, and
a main direction of the oscillations of an antenna structure of said base station, when said antenna structure has been assessed to be in the oscillation condition,
   based on a geometrical comparison between the generated electromagnetic print of the antenna of said base station and the corresponding reference electromagnetic print of said antenna.

According to an embodiment of the present invention, said radio measurements pertaining to the electromagnetic operation of an antenna of a base station carried out by a user equipment located within the cell corresponding to said base station comprise a signal strength of the antenna measured by said user equipment and indicative of a power outputted by said antenna as received by said user equipment.

According to an embodiment of the present invention, said electromagnetic print of an antenna of a base station generated by the antenna vibration monitoring system comprises a set of contour lines each one associated to a respective value of said signal strength of the antenna.

According to an embodiment of the present invention, each contour line of the set encloses geographic positions of user equipment, within the cell corresponding to said base station, which carried out a radio measurement providing for a signal strength corresponding to the value associated to said contour line.

According to an embodiment of the present invention, said radio measurements pertaining to the electromagnetic operation of an antenna of a base station carried out by said user equipment located within the cell corresponding to said base station further comprise at least one among:
a cell identifier identifying the cell corresponding to the base station comprising the antenna;
a geo-localization identifier identifying the geographic position of said user equipment when said signal strength has been measured by the user equipment;
a time stamp identifying a time when said signal strength has been measured by the user equipment;
a timing advance value indicative of a length of time a signal takes to travel between said base station and said user equipment.

Another aspect of the present invention relates to a mobile communication network.

The mobile communication network comprises a plurality of fixed-location base stations each providing radio coverage over a corresponding cell.

Each base station comprises at least one corresponding antenna structure comprising a supporting member supporting at least one antenna configured to radiate/receive radio waves to/from portions of the cell to allow user equipment within the cell to exchange data traffic.

The mobile communication network further comprises an antenna vibration monitoring system configured to:
collect radio measurements pertaining to the electromagnetic operation of an antenna of a base station, said radio measurements being carried out by user equipment located in the cell corresponding to said base station;
generate an electromagnetic print of said antenna using said collected radio measurements, said electromagnetic print providing an indication of how a radiation pattern of the antenna varies over time across the cell;
assess an oscillation condition of the antenna structure of said base station, in which the supporting member is oscillating, based on said generated electromagnetic print of the antenna of said base station.

Another aspect of the present invention relates to a method for monitoring a mobile communication network comprising a plurality of fixed-location base stations each providing radio coverage over a corresponding cell.

Each base station comprises at least one corresponding antenna structure comprising a supporting member supporting at least one antenna configured to radiate/receive radio waves to/from portions of the cell to allow user equipment within the cell to exchange data traffic.

The method comprises:
collecting radio measurements pertaining to the electromagnetic operation of an antenna of a base station, said radio measurements being carried out by user equipment located in the cell corresponding to said base station;
generating an electromagnetic print of said antenna using said collected radio measurements, said electromagnetic print providing an indication of how a radiation pattern of the antenna varies over time across the cell;
assessing an oscillation condition of the antenna structure of said base station, in which the supporting member is oscillating, based on said generated electromagnetic print of the antenna of said base station.

### BRIEF DESCRIPTION OF THE DRAWINGS

These and other features and advantages of the present invention will appear more clearly by reading the following detailed description of exemplary and non-limitative embodiments thereof. For its better intelligibility, the following description should be read making reference to the attached drawing, wherein:

FIG. 1 is a schematic representation of a mobile communication network according to an embodiment of the present invention;

FIG. 2A is a simplified view of an antenna structure of a generic base station of the mobile communication network of FIG. 1 when the antenna structure is in a rest condition;

FIG. 2B is a simplified view of an antenna structure of a generic base station of the mobile communication network of FIG. 1 when the antenna structure is in an oscillation condition;

FIG. 3A and FIG. 3B illustrates two exemplary contour lines generated by an antenna vibration monitoring system according to an embodiment of the present invention;

FIG. 4 depicts a contour line of an electromagnetic print and of a reference electromagnetic print according to an embodiment of the present invention;

FIG. 5 depicts a flow chart showing in terms of functional blocks the operations carried out by the antenna vibration monitoring system according to an embodiment of the present invention.

### DETAILED DESCRIPTION OF EXEMPLARY AND NON-LIMITATIVE EMBODIMENTS OF THE PRESENT INVENTION

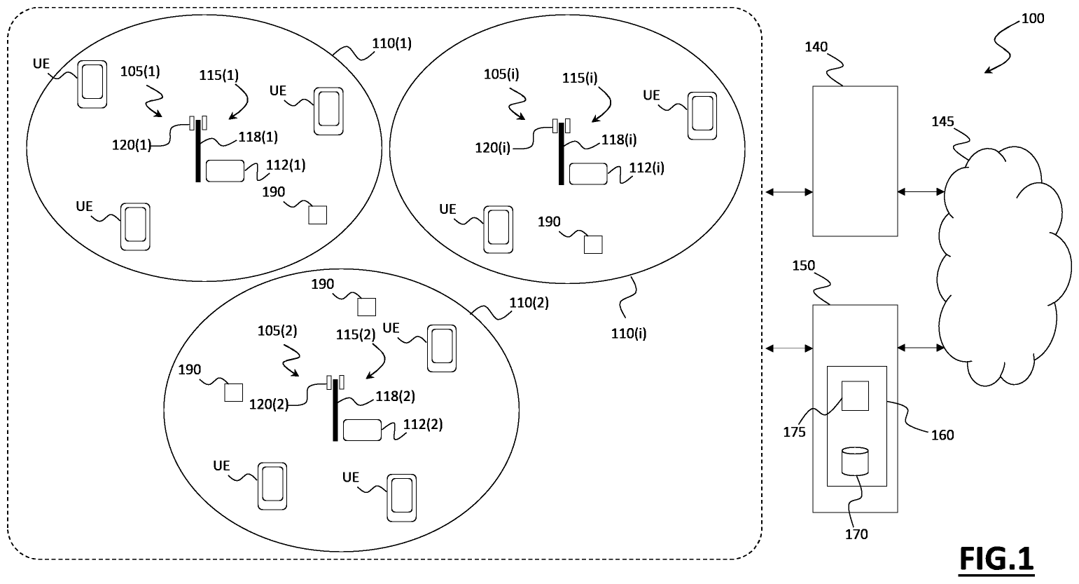

With reference to the drawing, FIG. 1 is a schematic representation of a mobile communication network 100 according to an embodiment of the present invention.

According to an embodiment of the present invention, the mobile communication network 100 comprises a plurality of fixed-location base stations 105(i) (i=1, 2, . . . ) providing radio coverage over a geographic area.

According to an embodiment of the present invention, each base station 105(i) is configured to provide radio coverage over (or, equivalently, is associated with) one or more corresponding portions of the geographic area, or cells 110(i).

In the exemplary and simplified scenario depicted in FIG. 1, each base station 105(i) is associated with a respective cell 110(i). In a practical scenario, each base station 105(i) may be associated with a plurality of cells, such as three cells.

In the exemplary and simplified scenario depicted in FIG. 1, each cell 110(i) has the shape corresponding to an ideal ellipse. However, in practice, the shape of a cell 110(i) may have a significantly different shape, e.g., due to geographical and/or propagation characteristics or constraints of the area where the cell 110(i) is located. Moreover, as will be described in greater details in the following, the shape and the size of a cell 110(i) may vary over time depending on environmental conditions.

According to an embodiment of the present invention, each base station 105(i) comprises one or more electronic apparatuses, globally identified in FIG. 1 with reference 112(i). Examples of electronic apparatuses 112(i) include, but are not limited to, transceivers and digital signal processors.

According to an embodiment of the present invention, each base station 105(i) comprises one or more antenna structures, globally identified in FIG. 1 with reference 115(i).

According to an embodiment of the present invention, each antenna structure 115(i) comprises one or more corresponding supporting members 118(i), such as a mast or a tower.

According to an embodiment of the present invention, each antenna structure 115(i) further comprises one or more corresponding antennas 120(i) supported by the corresponding supporting member(s) 118(i). Each antenna 120(i) is coupled to the corresponding electronic apparatuses 112(i) (e.g., to the transceivers) and is configured to radiate/receive electromagnetic waves (radio waves) to/from portions of the geographic area corresponding to the cell 110(i).

According to an embodiment of the present invention, each base station 105(i) is configured to allow user equipment UE within the respective cell 110(i) (and connecting/connected to the mobile communication network 100) to exchange data traffic, such as web browsing, e-mailing, voice, or multimedia data traffic.

User equipment UE may for example comprise personal devices owned by a user of the mobile communication network 100 (the user being for example a subscriber of services offered by the mobile communication network 100). Examples of user equipment UE comprise, but are not limited to, mobile phones, smartphones, tablets, personal digital assistants and computers.

According to an embodiment of the present invention, the base stations 105(i) are part of a radio access network of the mobile communication network 100.

The radio access network-and, more generally, the mobile communication network 100, may be based on any suitable radio access technology. Examples of radio access technologies include, but are not limited to, UTRA (“UMTS Terrestrial Radio Access”), WCDMA (“Wideband Code Division Multiple Access”), CDMA 2000, LTE (“Long Term Evolution”), LTE-Advanced, and NR (“New Radio”).

According to an embodiment of the present invention, the radio access network is communicably coupled with one or more core networks, such as the core network 140. The core network 140 may be any type of network configured to provide aggregation, authentication, call control/switching, charging, service invocation, gateway and subscriber database functionalities, or at least a subset (i.e., one or more) thereof.

According to an embodiment of the present invention, the core network 140 comprises a 4G/LTE core network or a 5G core network.

According to an embodiment of the present invention, the core network 140 is communicably coupled with other networks different from the mobile communication network 100, such as the Internet 145 and/or public switched telephone networks (not shown).

According to an embodiment of the present invention, the mobile communication network 100 is provided with “Self-Organizing Network” (SON) functionalities, i.e., functionalities that allow setting (i.e., tuning, adjusting, configuring) parameters of the mobile communication network 100, and particularly parameters of the cells 110(i), such as for example parameters regarding the antennas 120(i) (hereinafter, “antenna parameters”). Examples of antenna parameters include, but are not limited to, antenna electrical tilt, azimuth, gain, and antenna radiation pattern (e.g., pointing direction, directivity and width of one or more lobes of the pattern lobes exhibited by the antenna radiation pattern).

According to an embodiment of the present invention, the mobile communication network 100 comprises a SON module 150, i.e., a processing module that allows implementing the SON functionalities. The SON module 150 may be implemented by software, hardware, and/or a combination thereof.

According to an embodiment of the present invention, the SON module 150 is located external to the core network 140. According to alternative embodiments of the invention, the SON module 150 is located in the core network 140 (e.g., in one or more modules thereof) or in any other entity of the cellular network or of the mobile communication network 100. According to an embodiment of the present invention, the physical location of the SON module 150 depends on the implemented SON network architecture (e.g., distributed SON network, centralized SON network or hybrid SON network).

According to an embodiment of the present invention, the supporting members 118(i) of the antenna structures 115(i) are configured to oscillate when the antenna structures 115(i) are subjected to mechanical stresses caused by external causes—such as winds, earthquakes, impacts, acts of vandalism.

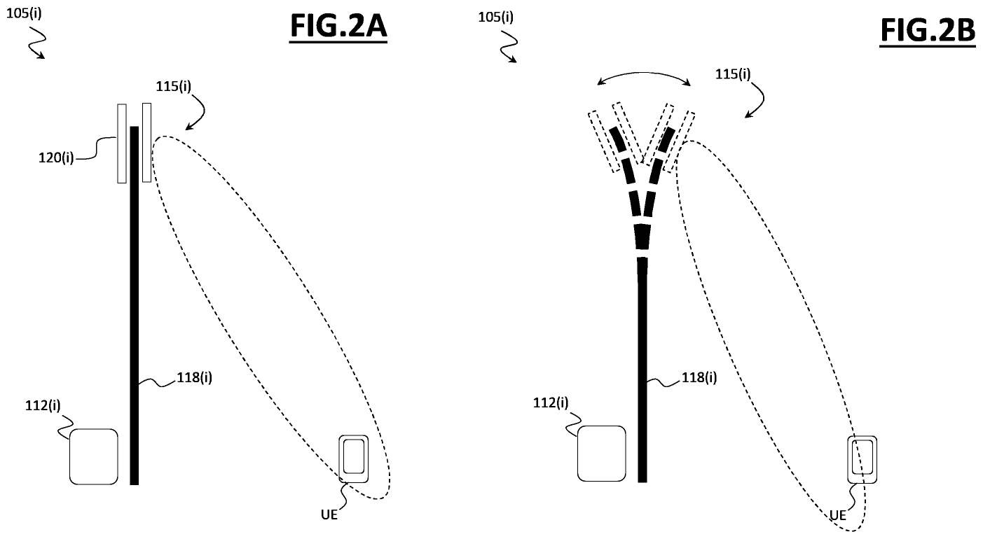

FIGS. 2A and 2B are simplified views showing an antenna structure 115(i) of a generic base station 105(i) when the supporting member 118(i) and the antennas 120(i) thereof are in a rest condition (FIG. 2A) and in an oscillation condition (FIG. 2B).

A generic user equipment UE located in the cell 110(i) receives from the antennas 120(i) radio waves whose strength depends on the radiation pattern RP of the antennas 120(i) and on the position P (distance, orientation, tilt) of the user equipment UE with respect to the antennas 120(i).

When the supporting member 118(i) is in a rest condition (FIG. 2A), i.e., when no mechanical stresses are being induced by external causes, the supporting member 118(i) stands still in a rest position together with the supported antennas 120(i). The position of the antennas 120(i) when the supporting member 118(i) is in the rest position is herein referred to as “antenna rest position” ARP.

When the supporting member 118(i) is oscillating about its rest position (FIG. 2B) because of mechanical stresses caused by external causes, the antennas 120(i) take a position AP(t) that evolves over time. Due to the oscillatory nature of this movement, the position AP(t) of the antennas 120(i) oscillates about the antenna rest position ARP.

Therefore, having a user equipment UE that is located at a specific location of the geographic area covered by the cell 110(i), the actual position P (in terms of mutual distance, orientation, tilt) of the user equipment UE with respect to the antennas 120(i) is constant when the supporting member 118(i) is in the rest condition, and varies over time when the supporting member 118(i) is oscillating. Therefore, the strength of the radio waves received by the user equipment UE from the antennas 120(i) varies over time. Due to the oscillatory nature of the movement of the supporting member 118(i), said variation in the strength of the radio waves received by the user equipment UE is generally an oscillatory variation.

Looking from a different perspective, when the supporting member 118(i) is oscillating, the radiation pattern RP of the antennas 120(i) experienced by a user equipment UE at a specific location varies over time. Due to the oscillatory nature of the movement of the supporting member 118(i), said variation of the radiation pattern RP is generally an oscillatory variation.

The radiation pattern RP of a generic antenna 120(i) has a corresponding horizontal beam aperture and a corresponding vertical beam aperture. The narrower the beam, the higher the antenna's gain at the beam, and the larger the radio coverage distance. For example, current antennas for 4G applications may have a horizontal beam aperture of 60° and a vertical beam aperture of 15°. Antennas for 5G applications may exhibit narrower beams, having horizontal and/or vertical beam apertures corresponding to few degrees only.

Therefore, even a small oscillation of the supporting member 118(i) of an antenna structure 115(i) may cause—at a position sufficiently distant from the antenna structure 115(i)—relatively large periodic variations in the power that can be received at said position. The entity of said variations in the receivable power strongly depends on the kind of the antenna 120(i) (e.g., its directivity) and on the size of the supporting member 118(i) thereof (e.g., its height with respect to the ground level). For example, an antenna structure 115(i) having an antenna 120(i) with a horizontal beam aperture of 60° and a vertical beam aperture of 15° supported by a supporting member 118(i) whose height is about 50 meters may exhibit a power density variation of 3 dB in response to a variation of the orientation of the supporting member 118(i) (with respect to the rest condition) of less than 1°.

According to an embodiment of the present invention, the mobile communication network 100 comprises an antenna vibration monitoring system 160 configured to assess oscillation conditions of the antenna structures 115(i)—in which the supporting members 118(i) and the antennas 120(i) thereof are oscillating—by observing variations over time of the radiation pattern RP of the antennas 120(i). According to an embodiment of the present invention, the antenna vibration monitoring system 160 is part of the SON module 150. However, similar considerations apply in case the antenna vibration monitoring system 160 is external to the SON module 150. The antenna vibration monitoring system 160 may be implemented by software, hardware, and/or a combination thereof.

The antenna vibration monitoring system 160 according to an embodiment of the present invention is configured to observe variations over time of the radiation pattern RP of the antennas 120(i) of a base station 105(i) based on radio measurements RM measured by user equipment UE located in the corresponding cell 110(i). According to an embodiment of the present invention, said radio measurements RM are measurements pertaining to the electromagnetic operation of the antennas 120(i) within the cell 110(i).

According to an embodiment of the present invention, said radio measurements RM comprise a signal strength SS(x) (or signal level) of the antenna 120(i) indicative of a power outputted by the antenna 120(i) as received by a user equipment UE located at a (geographic) position x within the cell 110(i). For example, the signal strength SS(x) is expressed in dB-microvolts per meter.

According to an embodiment of the present invention, the radio measurements RM carried out by a user equipment UE further comprise at least one among:
a cell identifier CI identifying the cell 110(i) corresponding to the base station 115(i) comprising the antenna 120(i);
a geo-localization identifier GL(x) identifying the geographic position x of the user equipment UE within the cell 110(i) when the signal strength SS(x) has been measured;
a time stamp TS identifying the time t when the signal strength SS(x) has been measured;
a timing advance value TA value indicative of a length of time a signal takes to travel between the base station 105(i) and the user equipment UE.

According to an embodiment of the present invention, the radio measurements RM are advantageously carried out by the user equipment UE through the known 3GPP “Minimization of Drive Test” (MDT) functionality already employed for enabling user equipment UE connected to a mobile communication network to collect radio measurements and associated location information, in order to assess network performance. For example, according to an embodiment of the present invention, the signal strength SS(x) is determined by carrying out a RSRP (“Reference Signal Received Power”) measurement providing for having the antenna 120(i) transmit an encoded signal comprising dedicated symbols, and user equipment UE receive and decode the received signal for obtaining a corresponding useful signal measurement based on the received symbols.

However, similar considerations apply in case the radio measurements RM are collected by the user equipment UE in a different way and/or according to a different functionality.

According to an embodiment of the present invention, the antenna vibration monitoring system 160 is configured to process the radio measurements RM carried out over time by user equipment UE located at geographic positions x covered by a cell 110(i) to accordingly generate a corresponding “electromagnetic print” EP(i)(t) of the corresponding antenna 120(i) showing an indication of how the radiation pattern RP thereof varies over time across the geographic area covered by the cell 110(i).

According to an embodiment of the present invention, the antenna vibration monitoring system 160 is configured to generate the electromagnetic print EP(i)(t) based on the idea that at a generic time t, the signal strength SS(x) of an antenna 120(i) will have values equal to (or comprised in an interval including) a specific value Vj at respective geographic positions x corresponding to the cell 110(i). Generally, higher/lower values Vj of the signal strength SS(x) correspond to geographic positions x that are closer/farther to/from the antenna 120(i).

According to an embodiment of the present invention, the antenna vibration monitoring system 160 is configured to calculate at a generic time/and for each one among a plurality of possible values Vj (j=1, 2, . . . ) a corresponding closed contour line CL(j)(t) enclosing the geographic positions x of the user equipment UE within the cell 110(i) which reported a measured signal strength SS(x) corresponding to said value Vj at said time t.

According to an embodiment of the present invention, the closed contour line CL(j)(t) corresponding to the value Vj of the signal strength SS(x) is generated as the smallest broken line enclosing the geographic positions x of the user equipment UE within the cell 110(i) which reported a measured signal strength SS(x) corresponding to said value Vj at said time t.

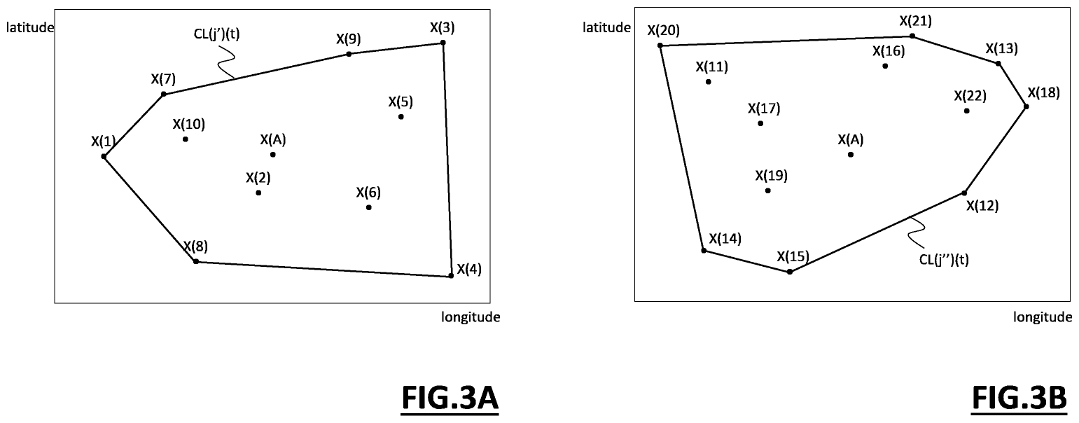

FIG. 3A and FIG. 3B illustrates two exemplary contour lines CL(j′)(t), CL(j″)(t) generated by the antenna vibration monitoring system 160 according to an embodiment of the present invention using radio measurements RM collected from user equipment UE within a cell 110(i) at a same time t (i.e., having a same or a corresponding time stamp TS) and corresponding to two different values Vj′, Vj″ of the signal strength SS(x).

The position x (in terms of latitude and longitude) of each user equipment UE(k) (k=1, 2, . . . )

within the geographic area covered by the cell 110(i) having measured at time t a signal strength SS(x) equal (or corresponding) to the value Vj′ (FIG. 3A) or equal (or corresponding) to the value Vj″ (FIG. 3B) is depicted with reference X(k). The position x (in terms of latitude and longitude) within the geographic area covered by the cell 110(i) of the base station 115(i) (and particularly, of the antenna structure 115(i)) is depicted with reference X(A).

In the example illustrated in FIG. 3A, user equipment UE(k) (k=1 to 10) have measured at time t a signal strength SS(x) equal (or corresponding) to the value Vj′. In the example illustrated in FIG. 3B, user equipment UE(k) (k=11 to 22) have measured at time t a signal strength SS(x) equal (or corresponding) to the value Vj″.

As can be seen in the examples illustrated in FIGS. 3A and 3B, the geometry of the contour lines CL(j′)(t), CL(j″)(t) is neither regular nor symmetrical, and the contour lines CL(j′)(t), CL(j″)(t) are not exactly centered about the position X(A) of the antenna structure 115(i). Moreover, there are several user equipment UE(k) that are far from the borders of the contour lines CL(j′)(t), CL(j″)(t), being instead located in substantially central portions of the geographic area encircled by the contour lines CL(j′)(t), CL(j″)(t). Reasons for these irregular behaviors comprise for example:
the presence of obstacles (e.g., buildings and/or trees) and/or weather conditions influencing the radio wave propagation between the antenna 120(i) and the user equipment;
imprecisions in the calculation of the geo-localization identifier GL(x) and of the signal strength SS(x);
alterations in the location and/or orientation of the user equipment.

According to an embodiment of the present invention, the electromagnetic print EP(i)(t) generated by the antenna vibration monitoring system 160 corresponding to a generic time t comprises a set of J closed contour lines CL(j)(t) (j=1, 2, . . . , J) calculated for a respective set of J values Vj (j=1, 2, . . . , J) of the signal strength SS(x) measured at time t.

According to an embodiment of the present invention, the antenna vibration monitoring system 160 is configured to assess an oscillation condition of an antenna structure 115(i)—i.e. a condition in which the supporting member 118(i) and the antenna 120(i) thereof is oscillating—by observing how the electromagnetic print EP(i)(t) of the corresponding antenna 120(i) evolves over time.

Particularly, when the supporting member 118(i) of the antenna structure 115(i) stands still in a rest condition, i.e., when no mechanical stresses are being induced thereto by external causes (as in the condition illustrated in FIG. 2A), the corresponding electromagnetic print EP(i)(t) of the antenna 120(i) is subjected to variations over time that are mainly due to errors/imprecisions in the radio measurements RM carried out by the user equipment UE, and/or to the actual spatial distribution of the user equipment UE over the geographical area covered by the corresponding cell 110(i). In any case, said errors/imprecisions, as well as the effect of the actual spatial distribution of the user equipment UE may be statistically compensated by considering a high amount of radio measurements RM carried out by a high number of different user equipment UE.

When the supporting member 118(i) of the antenna structure 115(i) is oscillating because of mechanical stresses that are being induced by external causes such as winds or earthquakes (as in the condition illustrated in FIG. 2B), the corresponding electromagnetic print EP(i)(t) of the antenna 120(i) is subjected to variations over time that are also due (in addition to the previously mentioned errors/imprecisions in the radio measurements RM, and/or to the actual spatial distribution of the user equipment UE) to the mechanical oscillation of the supporting member 118(i). The component of the variation over time of the electromagnetic print EP(i)(t) due to the mechanical oscillation of the supporting ember 118(i) is not compensated by having a high amount of radio measurements RM, since all the radio measurements RM carried out by the user equipment UE are subjected by the same variations induced by said mechanical oscillation of the supporting member 118(i).

According to an embodiment of the present invention, the antenna vibration monitoring system 160 is configured to calculate for each cell 110(i) a respective reference electromagnetic print ER(i) corresponding to the electromagnetic print EP(i)(t) of the antenna 120(i) when the supporting member 118(i) of the corresponding antenna structure 115(i) stands still in the rest condition. According to an embodiment of the present invention, the generation of the reference electromagnetic print ER(i) is carried out—e.g., in a training phase of the antenna vibration monitoring system 160—by using radio measurements RM collected in a situation in which it is assured that the supporting member 118(i) of the corresponding antenna structure 115(i) is still (i.e., in absence of eternal causes of mechanical stresses). For this purpose, according to an embodiment of the present invention, the antenna vibration monitoring system 160 comprises (or is coupled to) one or more storage modules 170 configured to store the radio measurements RM collected from the user equipment UE as well as data representing the reference electromagnetic prints ER(i) of the antennas 120(i) of the various cells 110(i).

According to an embodiment of the present invention, the antenna vibration monitoring system 160 is configured to assess an oscillation condition of an antenna structure 115(i)—i.e. a condition in which the supporting member 118(i) thereof is oscillating—of a cell 110(i) by comparing the current electromagnetic print EP(i)(t) of the corresponding antenna 120(i) with the respective reference electromagnetic print ER(i).

According to an embodiment of the present invention, the antenna vibration monitoring system 160 is configured to assess an oscillation condition of an antenna structure 115(i) by comparing a current evolution over time of the electromagnetic print EP(i)(t) of the corresponding antenna 120(i) with the respective reference electromagnetic print ER(i).

According to an embodiment of the present invention, as long as the electromagnetic print EP(i)(t) of an antenna 120(i) is substantially equal to the corresponding reference electromagnetic print ER(i), the antenna vibration monitoring system 160 assesses that the supporting member 118(i) of the antenna structure 115(i) is not oscillating.

According to an embodiment of the present invention, when the electromagnetic print EP(i)(t) of an antenna 120(i) varies over time (e.g., by a sufficiently large extent) with respect to the reference electromagnetic print ER(i), the antenna vibration monitoring system 160 assesses that the supporting member 118(i) of the antenna structure 115(i) is oscillating.

Thanks to the antenna vibration monitoring system 160 according to the embodiments of the present invention, it is possible to check in quasi-real-time the condition (rest or oscillating) of the deployed antenna structures 115(i) of the mobile communication network 100 without being forced to install dedicated sensors (such as gyroscope and/or accelerometers) on every antenna structure 115(i), dramatically reducing the installation and maintenance costs.

According to an embodiment of the present invention, the antenna vibration monitoring system 160 comprises or is coupled to an Artificial Intelligence (AI) unit 175 trained to discriminate between an oscillation condition and a rest condition of an antenna structure 115(i) by comparing a current evolution over time of the electromagnetic print EP(i)(t) of the corresponding antenna 120(i) with the respective reference electromagnetic print ER(i). According to an embodiment of the present invention, the AI unit 175 may be (at least partially) implemented through one or more cloud servers (not illustrated), for example connected to the antenna vibration monitoring system 160 through the internet 145.

According to an embodiment of the present invention, the AI unit 175 of the antenna vibration monitoring system 160 is trained (e.g., through machine learning procedures) to recognize when the variation over time of the electromagnetic print EP(i)(t) with respect to the reference electromagnetic print ER(i) is due to mechanical oscillations of the supporting member 118(i) of the antenna structure 115(i).

According to an embodiment of the present invention, the AI unit 175 of the antenna vibration monitoring system 160 is trained with a first train dataset DS1 comprising radio measurements RM collected in a situation in which it is assured that the supporting member 118(i) of the corresponding antenna structure 115(i) is still (i.e., in absence of external causes of mechanical stresses), and with a second train dataset DS2 comprising radio measurements RM collected in a situation in which it assured that the supporting member 118(i) of the corresponding antenna structure 115(i) is oscillating. For example, the radio measurements RM of the second train dataset DS2 are collected during a windy day, or when the supporting member 118(i) is forcibly caused to oscillate. According to an embodiment of the present invention, the train dataset DS1 and/or the train dataset DS2 may be stored in the storage module 170 of the antenna vibration monitoring system 160, and/or may be periodically updated to increase the efficiency of the antenna vibration monitoring system 160 based on new collected data.

According to an embodiment of the present invention, the training of the AI unit 175 may be carried out by exploiting also data generated by gyroscope and/or accelerometer sensors connected to supporting members 118(i) of the antenna structures 115(i) of a reduced subset of cells 110(i). The data generated by the gyroscope and/or accelerometer sensors when the supporting members 118(i) are still can be advantageously used to enrich the first train dataset DS1 and the data generated by the gyroscope and/or accelerometer sensors when the supporting members 118(i) are oscillating can be advantageously used to enrich the second train dataset DS2.

Returning back to FIG. 1, according to an embodiment of the present invention, additional radio measurements RM pertaining to the electromagnetic operation of the antennas 120(i) may be generated also by fixed communication terminals 190 that are located at fixed (geographic) positions x within the cells 110(i), such as for example Fixed Wireless Access (FWA) terminals. A fixed communication terminal 190 is a communication terminal that has communication capabilities similar to those of a mobile user equipment UE, the main difference being that the communication terminal 190 does not change its position x.

According to an embodiment of the present invention, the antenna vibration monitoring system 160 is configured to generate the electromagnetic prints EP(i)(t) of the antennas 120(i) by advantageously using the radio measurements RM carried out by the fixed communication terminals 190 in addition to the ones carried out by the (mobile) user equipment UE.

According to an embodiment of the present invention, the antenna vibration monitoring system 160 is configured to distinguish between fixed communication terminals 190 and (mobile) user equipment UE located in a cell 110(i) by means of a proper signaling analysis relating to the Quality of Service (QoS) of mobile operators for differentiating the offered services. Said signaling analysis may provide for exploiting QoS Class Identifier (QCI) data, Allocation and Retention Priority (ARP) data, Service Profile Identifier (SPID) data, Session-ID data and MTIMSI data. For example, the Session-ID data and the MTIMSI data relating to a fixed communication terminal 190 will probably remain constant over time.

In this way, the antenna vibration monitoring system 160 is able to identify which radio measurements RM pertain to terminals that are in fixed positions x. These radio measurements RM pertaining to terminals that are in fixed positions x produce statistic indicators that are more focused on variations in the radiation pattern RP of antennas 120(i) due to oscillations of the antenna structures 115(i) caused by external causes—such as winds, earthquakes, impacts, acts of vandalism—, being less influenced by the movement of the terminals generating the radio measurements RM.

According to an embodiment of the present invention, the antenna vibration monitoring system 160 is configured to determine some indicators adapted to further characterize and classify the oscillatory movement of an antenna structure 115(i) when an oscillation condition of the latter is determined.

According to an embodiment of the present invention, the antenna vibration monitoring system 160 is configured to determine an oscillation frequency F of the antenna structure 115(i) when the latter is assessed to oscillate by observing the frequency with which the electromagnetic print EP(i)(t) oscillates with respect to (e.g., about) the reference electromagnetic print ER(i).

According to an embodiment of the present invention, the antenna vibration monitoring system 160 is configured to determine an intensity/of the oscillations of the antenna structure 115(i) when the antenna structure 115(i) is assessed to oscillate based on a geometrical comparison between the electromagnetic print EP(i)(t) and the reference electromagnetic print ER(i).

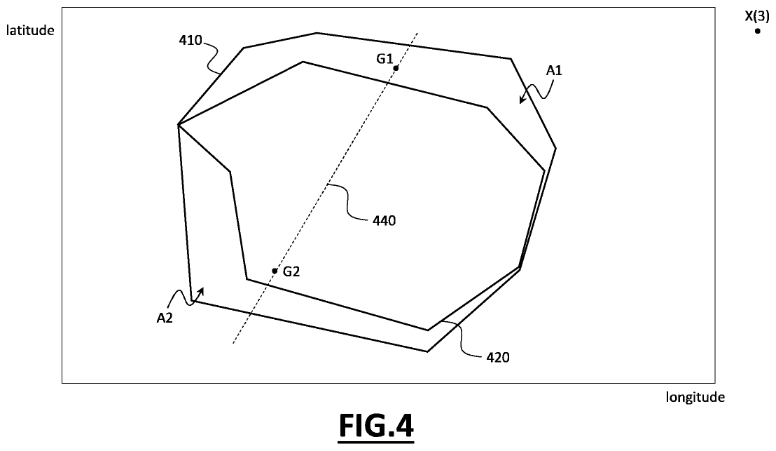

According to an exemplary embodiment of the present invention illustrated in FIG. 4, the antenna vibration monitoring system 160 is configured to determine the intensity I based on a difference DIFF between the area enclosed by a contour line CL(j)(t) of the electromagnetic print EP(i)(t) (identified in FIG. 4 with reference 410) and the area enclosed by the corresponding contour line CL(j)(t) (i.e., corresponding to a same value Vj of the signal strength SS(x)) of the reference electromagnetic print ER(i) (identified in FIG. 4 with reference 420). According to an embodiment of the present invention, the antenna vibration monitoring system 160 is configured to set the intensity I of the of the oscillations of the antenna structure 115(i) to a value proportional (e.g., linearly or exponentially proportional) to said difference DIFF. Similar considerations apply if the intensity I is calculated using said difference DIFF in a different way.

According to an embodiment of the present invention, the antenna vibration monitoring system 160 is configured to determine a main direction DIR of the oscillations of the antenna structure 115(i) when the antenna structure 115(i) is assessed to oscillate based on a geometrical comparison between the electromagnetic print EP(i)(t) and the reference electromagnetic print ER(i).

According to an embodiment of the present invention, the antenna vibration monitoring system 160 is configured to determine the main direction DIR by performing the following operations:
Cutout area portions are generated by cutting out the area subtended by a contour line CL(j)(t) of the reference electromagnetic print ER(i) from the area subtended by the corresponding contour line CL(j)(t) of the electromagnetic print EP(i)(t). In the example illustrated in FIG. 4, two cutout area portions are generated, identified with reference A1 and A2.
The two largest cutout area portions are selected, i.e., the two ones having the largest areas. In the example illustrated in FIG. 4, only two cutout area portions A1 and A2 have been generated, and therefore the cutout area portions A1 and A2 are both selected.
For each one of said two selected cutout area portions, the geometric center (or centroid) thereof is identified, i.e., the arithmetic mean position of all the points in the cutout area portion. In the example illustrated in FIG. 4, the geometric center of the cutout area portion A1 is identified as G1, and the geometric center of the cutout area portion A2 is identified as G2.
The main direction DIR of the oscillations of the antenna structure 115(i) is the direction along the line crossing the geometric centers of the two selected cutout area portions. In the example illustrated in FIG. 4, the main direction DIR lies along the line 440 crossing the geometric centers G1 and G2.

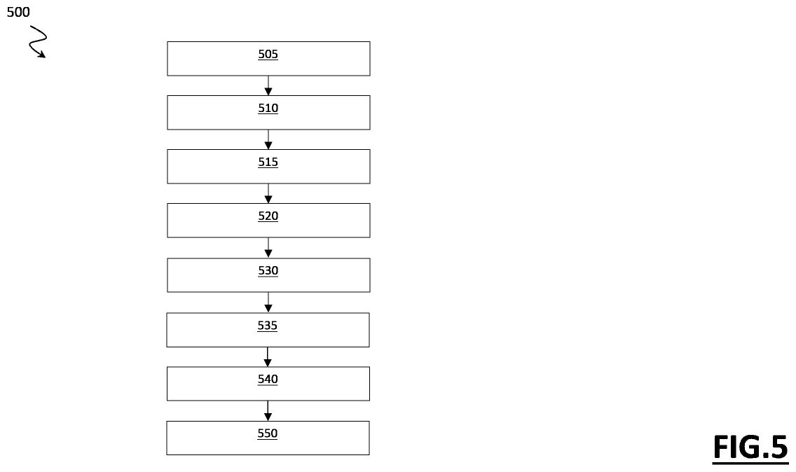

FIG. 5 depicts a flow chart 500 showing in terms of functional blocks the operations carried out by the antenna vibration monitoring system 160 according to an embodiment of the present invention.

According to an embodiment of the present invention, the antenna vibration monitoring system 160 collects the radio measurements RM carried out by the user equipment UE (and, if present, by the fixed communication terminals 190), and stores the collected radio measurements RM in the storage module 170 (block 505). According to an embodiment of the present invention, the radio measurements RM are periodically sent by the user equipment UE and received by the base station 105(i) of the cell 110(i) serving the user equipment UE. Then, the radio measurements RM received by the base station 115(i) are forwarded to the antenna vibration monitoring system 160. According to an embodiment of the present invention, each user equipment UE may collect several radio measurements RM before transmitting them to the base station 105(i). According to another embodiment of the present invention, each radio measurement RM collected by a user equipment UE may instead be directly transmitted to the base station 105(i).

According to an embodiment of the present invention, the data stored in the storage module 170 is arranged in a corresponding database comprising for each radio measurement RM (at least a subset of) the following data.
CI: the identifier identifying the cell 110(i) which was serving the user equipment UE when the user equipment UE carried out the measurement;
DATE: an identifier identifying the date of when the measurement has been sent to the base station 105(i);
TIME: an identifier identifying the time of when the measurement has been sent to the base station 105(i);
TS: the time stamp identifying the time/when the measurement has been carried out;
HOME_NETWORK: an identifier identifying the Public Land Mobile Network (PLMN) of the cell 110(i);
MIMSI: the MIMSI associated to the communication link between the user equipment UE and the base station 105(i);
LATITUDE: the latitude coordinate (e.g., in the WGS84 format) of the user equipment UE when the user equipment UE carried out the measurement;
LONGITUDE: the longitude coordinate (e.g., in the WGS84 format) of the user equipment UE when the user equipment UE carried out the measurement;
UNCERT_SEM_MNR: an identifier identifying the semi-minor axis of the uncertainty ellipse/ellipsoid;
UNCERT_SEM_MJR: an identifier identifying the semi-major axis of the uncertainty ellipse/ellipsoid;
ORIENT_MJR_AXIS: an identifier identifying an orientation of the semi-major axis of the uncertainty ellipse/ellipsoid;
ALTITUDE: an identifier identifying an altitude of the user equipment UE when the user equipment UE carried out the measurement;
CARRIER_FREQ_PCELL: an identifier identifying the carrier frequency used by the antenna 120(i);
CELLID_PCELL: an identifier identifying the EUTRA CELL ID of the cell 110(i);
RSRP_PCELL: the signal strength SS(x) of the antenna 120(i) indicative of a power outputted by the antenna 120(i) as received by the user equipment UE;
RSRQ_PCELL: an identifier of the quality of the signal outputted by the antenna 120(i) as received by the user equipment UE.

Other data can also be provided, such as the coordinates (latitude and longitude) of an elementary portion (pixel) of the geographic area including the position of the user equipment UE, used for averaging purposes when the radio measurements RM are carried out according to the MDT functionality, as well as data regarding cells adjacent to the cell 110(i).

According to an embodiment of the present invention, the antenna vibration monitoring system 160 generates for each cell 110(i) (or for a selected subset of cells 110(i)) a corresponding electromagnetic print EP(i)(t) exploiting the collected radio measurements RM as previously described (block 510).

According to an embodiment of the present invention, the antenna vibration monitoring system 160 then observes how the electromagnetic prints EP(i)(t) evolve over time (block 515). For this purpose, according to an embodiment of the present invention, the antenna vibration monitoring system 160 continuously updates the electromagnetic prints EP(i)(t) with data coming from new radio measurements RM.

The variations that can be observed over time in an electromagnetic print EP(i)(t) of an antenna 120(i) may be due by one or more of the following causes:
oscillations of the antenna structure 115(i) generated by mechanical stresses induced by external causes such as winds, earthquakes, or acts of vandalism;
presence of obstacles (e.g., a hand of the user of the user equipment UE that is covering the antenna of the latter) altering the radio wave propagation between the antenna 120(i) and the user equipment UE;
weather conditions (e.g., rain) altering the radio wave propagation between the antenna 120(i) and the user equipment UE;
imprecisions of the radio measurements RM (concerning the position of the user equipment UE and/or the measured signal strength);
modifications of the position and/or orientation of the user equipment UE.

According to an embodiment of the present invention, the antenna vibration monitoring system 160 is configured to compare each observed evolution over time of the electromagnetic prints EP(i)(t) with the respective reference electromagnetic print ER(i) (block 520). According to an embodiment of the present invention, said comparison is carried out by the AI unit 175 of the antenna vibration monitoring system 160.

According to an embodiment of the present invention, in order to carry out this comparison, the antenna vibration monitoring system 160 carries out a statistical analysis (e.g., using the known generalized method of moments) in order to decompose the observed variations over time of the electromagnetic prints EP(i)(t) into variation components each one due to a different kind of cause (e.g., oscillations of the antenna structure 115(i), presence of obstacles, weather conditions, radio measurements imprecisions, position and/or orientation alterations). In this way, it is possible to isolate the variations of the electromagnetic prints EP(i)(t) due to the oscillations of the antenna structure 115(i) from the variations due to other causes, reducing thus the occurrence of wrong interpretations.

According to an embodiment of the present invention, the comparison between the observed evolution over time of the electromagnetic prints EP(i)(t) and the respective reference electromagnetic print ER(i) is carried out by taking into account also data regarding the antenna structures 115(i), such as the height/material/shape/type of the supporting members 118(i) thereof, and/or typical wind characteristics of the geographic area where the antenna structures 115(i) are located.

Then, according to an embodiment of the present invention, the antenna vibration monitoring system 160 assesses (block 530) if an antenna structure 115(i) of a base station 105(i) is oscillating or not based on said comparison between the variations of the electromagnetic print EP(i)(t) and its respective reference electromagnetic print ER(i) carried out at block 520. According to an embodiment of the present invention, this assessment is carried out by the AI unit 175, which is properly trained to discriminate between an oscillation condition and a rest condition of an antenna structure 115(i) by comparing a current evolution over time of the electromagnetic print EP(i)(t) of the corresponding antenna 120(i) with the respective reference electromagnetic print ER(i).

According to an embodiment of the present invention, when an antenna structure 115(i) is determined to oscillate, the antenna vibration monitoring system 160 may further determine (535) the oscillation frequency F of such antenna structure 115(i) by observing the frequency with which the corresponding electromagnetic print EP(i)(t) oscillates with respect to (e.g., about) the reference electromagnetic print ER(i).

Moreover, according to an embodiment of the present invention, when an antenna structure 115(i) is determined to oscillate, the antenna vibration monitoring system 160 may further determine (540) the intensity/and/or the direction DIR of the oscillations of such antenna structure 115(i) based on a geometrical comparison between the electromagnetic print EP(i)(t) and the reference electromagnetic print ER(i) (as previously described with reference to FIG. 4).

According to an embodiment of the present invention, the antenna vibration monitoring system 160 may, e.g., periodically, output (block 550) a report REP showing the condition (rest or oscillating) of the antenna structures 115(i) of the mobile communication network 100. According to an embodiment of the present invention, the report REP may further specify for each antenna structure 115(i) that is assessed to be in the oscillation condition, at least one among the oscillation frequency F, the oscillation intensity I, and the oscillation direction DIR. According to an embodiment of the present invention, the report REP may be also outputted in a graphical form, such as for example in the form of a map graphically depicting the portions of the geographic area wherein antenna structures 115(i) that are oscillating are located.

Additionally, the report REP may be also advantageously exploited to keep track of the evolution of environmental conditions that are causing the oscillations, such as for example the propagation of seismic shocks across the geographic area or of a weather front.

According to an embodiment of the present invention, the report REP outputted by the vibration monitoring system 160 may be advantageously exploited for scheduling maintenance operations of the antenna structures 115(i). For example, if the report REP shows that some of the antenna structures 115(i) are subjected to oscillations, a maintenance team may be sent to inspect and/or repair said antenna structures 115(i).

According to an embodiment of the present invention, the report REP outputted by the vibration monitoring system 160 may be advantageously exploited for calibrating the antenna parameters (e.g., transmitted power, tilt, gain) of the antennas 120(i) of antenna structures 115(i) that are oscillating to compensate for the alterations in the radio coverage caused by the oscillations.

According to an embodiment of the present invention, the report REP outputted by the vibration monitoring system 160 may be directly used by the SON module 150 to automatically calibrate the antenna parameters of the antennas 120(i) of antenna structures 115(i) that are oscillating to compensate for the alterations in the radio coverage caused by the oscillations.

Naturally, in order to satisfy local and specific requirements, a person skilled in the art may apply to the invention described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

More specifically, the present invention lends itself to be implemented through an equivalent method (by using similar steps, removing some steps being not essential, or adding further optional steps); moreover, the steps may be performed in different order, concurrently or in an interleaved way (at least partly).

1. An antenna vibration monitoring system for assessing oscillations of antenna structures of fixed-location base stations of a mobile communication network, each base station providing radio coverage over a corresponding cell, each base station comprising at least one corresponding antenna structure comprising a supporting member supporting at least one antenna configured to radiate/receive radio waves to/from portions of the cell to allow user equipment within the cell to exchange data traffic, the antenna vibration monitoring system being configured to:
collect radio measurements pertaining to the electromagnetic operation of an antenna of a base station, said radio measurements being carried out by user equipment located in the cell corresponding to said base station;
generate an electromagnetic print of said antenna using said collected radio measurements, said electromagnetic print providing an indication of how a radiation pattern of the antenna varies over time across the cell;
assess an oscillation condition of the antenna structure of said base station, in which the supporting member is oscillating, based on said generated electromagnetic print of the antenna of said base station.

2. The antenna vibration monitoring system of claim 1, wherein the antenna vibration monitoring system is further configured to:
store for each base station a corresponding reference electromagnetic print of the antenna of said base station corresponding to the electromagnetic print of said antenna when the supporting member supporting said at least one antenna is in a rest condition,
assess said oscillation condition of the antenna structure of said base station by comparing said generated electromagnetic print of the antenna of said base station with the reference electromagnetic print of said antenna.

3. The antenna vibration monitoring system of claim 2, wherein the antenna vibration monitoring system is configured to assess a rest condition of said antenna structure of said base station, in which the supporting member thereof is not oscillating, when said generated electromagnetic print of the antenna of said base station is substantially equal to said reference electromagnetic print of the antenna of said base station.

4. The antenna vibration monitoring system of claim 2, wherein the antenna vibration monitoring system is configured to assess said oscillation condition of the antenna structure of said base station when said generated electromagnetic print of the antenna of said base station varies over time with respect to said reference electromagnetic print of the antenna of said base station.

5. The antenna vibration monitoring system of claim 3, wherein the antenna vibration monitoring system comprises or is coupled to an artificial intelligence unit trained to discriminate between said rest condition and said oscillation condition of the antenna structure of a base station by comparing a current evolution over time of the generated electromagnetic print of the antenna of said base station with the reference electromagnetic print of the antenna of said base station.

6. The antenna vibration monitoring system of claim 5, wherein said artificial intelligence unit is trained with:
a first data set comprising radio measurements collected in a situation in which it is assured that the antenna structure of said base station is in the rest condition;
a second data set comprising radio measurements collected in a situation in which it is assured that the antenna structure of said base station is in the oscillation condition.

7. The antenna vibration monitoring system of claim 5, wherein the antenna structure of said base station further comprises at least one between gyroscope and accelerometer sensors coupled to the supporting member of said base station, said artificial intelligence unit being further trained by exploiting also data generated by said gyroscope and/or accelerometer sensors.

8. The antenna vibration monitoring system of claim 2, wherein the antenna vibration monitoring system is configured to determine an oscillation frequency of an antenna structure of a base station, when said antenna structure has been assessed to be in the oscillation condition, based on a frequency with which the generated electromagnetic print of the antenna of said base station oscillates with respect to the reference electromagnetic print of said antenna.

9. The antenna vibration monitoring system of claim 2, wherein the antenna vibration monitoring system is configured to determine at least one between:
an intensity of the oscillations of an antenna structure of a base station, when said antenna structure has been assessed to be in the oscillation condition, and
a main direction of the oscillations of an antenna structure of said base station, when said antenna structure has been assessed to be in the oscillation condition,
based on a geometrical comparison between the generated electromagnetic print of the antenna of said base station and the corresponding reference electromagnetic print of said antenna.

10. The antenna vibration monitoring system of claim 1, wherein said radio measurements pertaining to the electromagnetic operation of an antenna of a base station carried out by a user equipment located within the cell corresponding to said base station comprise a signal strength of the antenna measured by said user equipment and indicative of a power outputted by said antenna as received by said user equipment.

11. The antenna vibration monitoring system of claim 10, wherein:
said electromagnetic print of an antenna of a base station generated by the antenna vibration monitoring system comprises a set of contour lines each one associated to a respective value of said signal strength of the antenna;
each contour line of the set encloses geographic positions of user equipment, within the cell corresponding to said base station, which carried out a radio measurement providing for a signal strength corresponding to the value associated to said contour line.

12. The antenna vibration monitoring system of claim 10, wherein said radio measurements pertaining to the electromagnetic operation of an antenna of a base station carried out by said user equipment located within the cell corresponding to said base station further comprise at least one among:
a cell identifier identifying the cell corresponding to the base station comprising the antenna;
a geo-localization identifier identifying the geographic position of said user equipment when said signal strength has been measured by the user equipment;
a time stamp identifying a time when said signal strength has been measured by the user equipment;
a timing advance value indicative of a length of time a signal takes to travel between said base station and said user equipment.

13. A mobile communication network comprising a plurality of fixed-location base stations each providing radio coverage over a corresponding cell, each base station comprising at least one corresponding antenna structure comprising a supporting member supporting at least one antenna configured to radiate/receive radio waves to/from portions of the cell to allow user equipment within the cell to exchange data traffic, the mobile communication network further comprising an antenna vibration monitoring system configured to:
collect radio measurements pertaining to the electromagnetic operation of an antenna of a base station, said radio measurements being carried out by user equipment located in the cell corresponding to said base station;
generate an electromagnetic print of said antenna using said collected radio measurements, said electromagnetic print providing an indication of how a radiation pattern of the antenna varies over time across the cell;
assess an oscillation condition of the antenna structure of said base station, in which the supporting member is oscillating, based on said generated electromagnetic print of the antenna of said base station.

14. A method for monitoring a mobile communication network comprising a plurality of fixed-location base stations each providing radio coverage over a corresponding cell, each base station comprising at least one corresponding antenna structure comprising a supporting member supporting at least one antenna configured to radiate/receive radio waves to/from portions of the cell to allow user equipment within the cell to exchange data traffic, the method comprising:
collecting radio measurements pertaining to the electromagnetic operation of an antenna of a base station, said radio measurements being carried out by user equipment located in the cell corresponding to said base station;
generating an electromagnetic print of said antenna using said collected radio measurements, said electromagnetic print providing an indication of how a radiation pattern of the antenna varies over time across the cell;
assessing an oscillation condition of the antenna structure of said base station, in which the supporting member is oscillating, based on said generated electromagnetic print of the antenna of said base station.
